(19) United States
(12) Patent Application Publication
(10) Pub. No.: US 2009/0080282 A1
(43) Pub. Date: Mar. 26, 2009

(54) Mixing Machine For Components

(76) Inventor: Olaf Skibba, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/236,300

(22) Filed: Sep. 23, 2008

(30) Foreign Application Priority Data
Sep. 24, 2007 (DE) 10 2007 045 533.1

(51) Int. Cl. B29C 47/10

(52) U.S. Cl. 366/76.2; 366/76.93

(57) ABSTRACT

An extrusion conveying apparatus, including an extruder that operates as a mixing device and is laterally supplied with components that are to be mixed, in particular components of a rubber mixture or thermoplastic elastomer. A volumetrically operating conveyor, in particular a gear pump, is connected to the output side of the extruder. A rotational speed or feed rate of the extruder is adjustable independently of the feed rate and volume flow of the conveyor. n−1 volumetric subsidiary conveyors are provided for passage of components therethrough where there are n components of a mixture. In particular component n is supplied in an undosed manner. A rotational speed or feed rate of the subsidiary conveyors is adjustable independently of the feed rate of the volumetrically operating conveyor.

The instant application should be granted the priority date Sep. 24, 2007 the filing date of the corresponding German patent application DE 10 2007 045 533.1.

### BACKGROUND OF THE INVENTION

The invention relates to an extrusion conveying apparatus having an extruder that operates as a mixing device and that can be laterally supplied with components that are to be mixed, in particular components of a rubber mixture or thermoplastic elastomer (TPE), whereby a volumetrically acting conveyor, in particular a gear pump, is connected to an output side of the extruder, and whereby the components that are supplied pass through volumetric subsidiary conveyors, which in particular are also embodied as gear pumps and the rotation speed or feed rate of which is adjustable independently of the feed rate of the volumetrically acting conveyor.

Conveying apparatuses of this kind are employed in order to produce a mixture to be extruded from a plurality of components. It is known that the mixing of components that are to yield a compound or substance to be extruded, is carried out producing different mixing qualities, wherein particular components tend to intermix or intermingle with a good uniformity whereas others are difficult to intermix.

In order to allow for mixing problems of this kind that also depend on corresponding dosing or metering requirements, numerous different designs have become known. For example it has been proposed to mix in advance components that are difficult to mix. Further, it has also been proposed to provide a separate conveying apparatus for each component that is to be mixed, whereby the conveying apparatus consists of an extruder screw and a volumetric conveying apparatus connected thereto. This approach offers the advantage of being able to achieve a relatively precise volumetric dosing or dosage as the apportionment or dispensing of the component into the actual mixing device can then be carried out in a precisely dosed manner.

On the other hand, a solution or approach of this kind requires a plurality of extruder screws and volumetric conveyors that for the most part are embodied as gear pumps. Solutions of this kind are often expensive and maintenance-extensive to this extent since each subsidiary conveyor must be maintained separately.

One approach by which one or more components can be supplied by means of one main conveyor or one or more subsidiary conveyors is known from DE 10 2005 050 619 A1. With this solution a total of three volumetric conveyors is required for providing a mixture consisting of two components.

Despite the work required, with such a solution the mixing quality, especially with mixtures having at least two components difficult to mix, is still capable of improvement.

In order to improve the mixing quality it has already been known to provide so-called transfer mix regions, or for example pin extruder regions, whereby for example reference is to be made to DE-A1 10 2005 048 846.3. In a transfer mix zone the opening cross-section for the substance to be extruded is offset radially in an outward direction into the region of the extruder housing during the progression of the extruder screw and then radially in an inward direction toward the extruder screw.

On the other hand, the invention has the object of keeping the time and effort for providing a multi-component extrusion conveying apparatus of the aforementioned general type as low as possible, but nevertheless to ensure a particularly good mixing result with components that exhibit poor mixing behavior.

### BRIEF DESCRIPTION OF THE DRAWING

Further advantages, details and features emerge from the following description of an extrusion conveying device in an exemplary embodiment according to the invention using the drawing, in which:

FIG. 1 the only figure of the drawing shows a diagrammatic view of a extrusion conveyor device according to the invention.

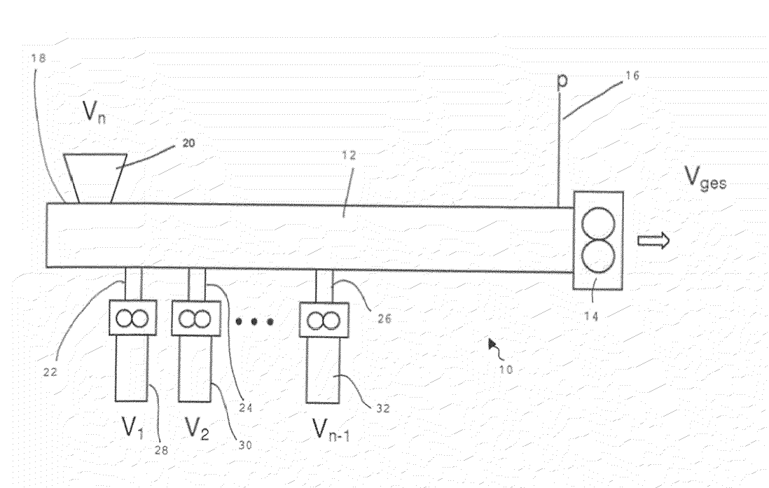

### SUMMARY OF THE INVENTION

This object is inventively realized by an extrusion conveying apparatus where for providing n components of a mixture, n−1 volumetric subsidiary conveyors are provided and in particular component n is supplied in no specific dosage or in an undosed manner, and wherein the rotational speed or feed rate of the extruder is adjustable independently of the feed rate and volume flow of the volumetrically operating conveyor.

According to the invention it is intended to use the output volume flow as the basis for calculating the individual volume flows of subsidiary conveyors. The output volume flow V_{ges} is as follows:

V_{ges}=V₁+V₂+ . . . +Vₙ₋₁+Vₙ

Correspondingly, the volume flow Vₙ of the component n is as follows:

Vₙ=V_{ges}−(V₁+V₂+ . . . +Vₙ₋₁)

According to the invention it is particularly expedient that due to the independent adjustment of the rotational speed or feed rate of the extruder relative to the feed rate of the volumetrically acting conveyor, a constant high mixing quality can be realized.

Surprisingly, this measure also solves the problems that arise when components are to be mixed that are difficult to intermix; by considerably increasing the feed rate of the extruder compared to the feed rate of the volumetrically acting conveyor a good mixture can then be achieved. For example, the feed rates can be set such that the output pressure of the extruder is a multiple of the rated input pressure of the volumetrically acting conveyor. Even if closer examinations have yet to be carried out, it is assumed that the pressure differences lead to intensive high pressure post-mixing in the transition area, which ensures the desired mixing effect by choosing the suitable arrangement for problematic mixtures.

It is to be understood that with less problematic mixing components, the feed rate of the extruder can be reduced to an conventional value in order not to consume energy unnecessarily to this extent.

The independent set-up or adjustment necessitates the conveying effect of the individual subsidiary conveyors to be set correspondingly. This is comparably costly, especially in the case that a plurality of subsidiary conveyors is provided for a large number n of components. On the other hand, the adjustment of the subsidiary conveyors for adaption to the extruder feed rate is necessary in order to exactly maintain the mixing ratios. Surprisingly, the mixing ratio can also be maintained if only n−1 volumetrical subsidiary conveyors are employed. The component n can then be supplied in the form of feed strips or granulate material, whereby the feed device can be embodied in any suitable way. Surprisingly, the desired mixing ratio can nevertheless be achieved by correspondingly calculating the necessary individual feed rates, even if the rotary speed of the extruder is increased.

Pursuant to the invention it is particularly expedient that there is provided a volumetrically acting conveyor at the end of the extruder in any case. Thus, the total feed rate is exactly defined, whereby also conveying fluctuations due to the elasticity of the system are compensated by exactly controlling the volumetric conveyor.

Pursuant to the invention it is advantageous if the component n is supplied in an undosed manner. However, a dosed supply is not impossible but if feed strips or granulate material are added for example, by doing so the system elasticity can be counter-balanced or compensated according to the invention, and unhealthy high pressures on the input side of the extruder that can lead to damages of the material due to the high temperatures, can thus be avoided more easily. Typically, components are fed in this case that are less critical and of relatively low importance for the later characteristics of the material with regard to its mixing ratio.

In this connection therewith, it is preferred that the component n is supplied on the input side of the extruder. This ensures that already in the region of the feed position of the first subsidiary conveyor, the relatively uncritical component n is existent in the extruder screw such that an intermixing process takes also place at that position.

It is preferred to select the component 1, i.e. the component supplied by the first subsidiary conveyor, in such a manner that this component is the component that is most difficult to mix. This ensures that over the progression of the extruder an especially good mixture can be achieved. Accordingly, the component n−1 is supplied considerably more far downstream, whereby it is preferred to use the component n−1 as the component that is intermingles most easily.

By the use of multiple-screw extruders, the possibilities for supplying the components can be considerably increased and a still better adjustment to the components to be mixed can be realized.

The invention is also well-suited for the use of thermoplastic elastomers. A relatively long extruder screw can be employed for the cross-linking or polymerization process. The rubber component can be prepared separately, with reference to the total mixture in a ratio of 20 to 40% for example, whereby filling material can be supplied via the subsidiary conveyors for example. The subdivision elastomer/thermoplastic by means of two separate extruder screws also offers the advantage that material damages relative to one another can be avoided to a large extent such that also peroxides can be employed instead of phenolic resin, resulting in improved cross-linking.

In a further advantageous embodiment a strainer-filter is provided downstream of the volumetric conveyor. This strainer-filter is preferably exchangeable and is realized in a region of enlarged cross-section of flow, i.e. in a known fashion conventionally upstream of the extrusion nozzle. The quality can thus be further improved, whereby it is appreciated that any other filters can be provided there, too. The region of the enlarged cross-section of flow that results in an enlarged conveying cross-section also acts as a kind of buffer and as ra zone for slowing down or calming the material.

Any selection and pre-preparation of the components to be mixed are possible. For example, a basic mixture and a pre-batch as well as further components, if applicable, can be brought together, whereby internal or external mixing apparatuses can be used in addition.

As volumetric conveyors classical gear conveyors with two meshing gears can be taken in consideration, but also planetary pumps or any other volumetric conveyor devices are possible.

Further specific features and advantages of the present application will be described in detail subsequently.

### Description of Specific Embodiments

The extrusion conveying apparatus 10 shown in the figure includes an extruder 12 constituting the central element of the extrusion conveying apparatus. The extruder is intended for the extrusion and conveying of extrudable mixtures including rubber mixtures and thermoplastic elastomers (TPEs) for example. The extruder is intended for delivering a volume flow that is designated with V_{ges} in this case. A volumetric conveyor 14 that is embodied as a gear pump, is provided on the output side of the extruder 12. The drive mechanism of the gear pump 14 is independent of the drive mechanism of the extruder 12.

Further, a pressure sensor 16 that measures the pressure existing at that position and that adjusts the drive speed of the extruder 12 correspondingly is provided on the output side of the extruder 12.

Various feeding positions or locations are provided laterally on the extruder 12. At a first feeding position 18 a feeding apparatus 20 is mounted by means of which particular components or a specific component of the mixture that is to be extruded are supplied. The component is supplied with a volume flow Vₙ, whereby by means of the lateral supply a pre-mixing by the extruder screw of the extruder is already realized in a known fashion.

Downstream of the feeding position 18 numerous further feeding positions 22, 24, 26 are provided that are connected to subsidiary conveyors 28, 30, 32 that provide the extruder with the components 1, 2 to n−1. Each supply takes place in a given volume flow designated with V₁, V₂ to Vₙ₋₁, respectively.

From the relationship or ratio of these subsidiary volume flows that is adjusted according to the desired mixing ratio supply or conveying volume of the feeding apparatus 20 Vₙ with respect to Vₙ=V_{ges}−(V₁+V₂+ . . . +Vₙ₋₁) follows.

Depending on the components to be mixed, the rotational speed of the extruder 12 can be adjusted to be faster or slower and according to the invention independently of the feed rate of the conveying apparatus 14. The minimal rate coincides to the conveying amount or volume that is always necessary for filling or charging the volumetric conveyor device 14. This feed rate corresponds to a pressure P_{ges, min}. However, the output pressure that is measured at the pressure sensor 16 and that is adjustable by the rotational speed of the extruder 12, can be selected to be considerably higher, for example is can increase to the twofold, threefold or even fourfold output pressure. Thus, an especially expedient intermixing can be achieved if the materials to be mixed show the corresponding features.

Of course it is to be understood that any modifications are possible without departing from the scope of the invention. Thus, by means of further pressure sensors it is possible to measure and adjust, if necessary, working pressures. Further any desired extra or special mixing elements can be employed in the region between the feeding position 26 and the pressure sensor 16, such as for example a transfer mix region or a pin extruder region. It is also possible to adjust the temperature of the extruder 12 over a wide range as required. For example, it can be useful to realize an especially intensive cooling at the output side of the extruder according to the countercurrent principle or the principle of countervailing influence if a very high end pressure, for example of 250 bar, is applied to the extruder 12.

For determining the volume flow V_{ges}, a weight measurement is expendiently carried out downstream of the conveyor 14, for example by means of a metering scale.

The specification incorporates by reference the disclosure of German priority document DE 10 2007 045 533.1 filed Sep. 24, 2007.

The present invention is, of course, in no way restricted to the specific disclosure of the specification and drawing, but also encompasses any modifications within the scope of the appended claims

What I claim is:

1. An extrusion conveying apparatus, comprising:
an extruder that operates as a mixing device and is adapted to be laterally supplied with components that are to be mixed, in particular components of a rubber mixture or thermoplastic elastomer;
a volumetrically operating conveyor, in particular a gear pump, connected to an output side of said extruder, wherein a rotational speed or feed rate of said extruder is adjustable independently of a feed rate and volume flow of said volumetrically operating conveyor; and
volumetric subsidiary conveyors, wherein for n components of a mixture, n−1 volumetric subsidiary conveyors are provided for passage of components therethrough, further wherein in particular component n is supplied in an undosed manner, further wherein a rotational speed or feed rate of said volumetric subsidiary conveyors is adjustable independently of the feed rate of said volumetrically operating conveyor, and wherein said volumetric subsidiary conveyors are also in particular embodied as gear pumps.

2. An extrusion conveying apparatus according to claim 1, which further includes a feeding apparatus for component n, further wherein said feeding apparatus is embodied as a hopper or funnel, and wherein component n is in the form of feed strips or granulate material.

3. An extrusion conveying apparatus according to claim 2, wherein said feeding apparatus for the component n is disposed upstream of feeding or supply locations of components 1 to n−1.

4. An extrusion conveying apparatus according to claim 1, which includes at least one pressure sensor disposed on the output side of said extruder, wherein said at least one pressure sensor is connected to a control device for regulation of the rotational speed of said extruder.

5. An extrusion conveying apparatus according to claim 1, which includes at least one pressure sensor for regulating the feed rate of said extruder in such a way that said feed rate is always greater than a pressure (P_{ges, min}) that is necessary for a complete filling or charging of said volumetrically operating conveyor.

6. An extrusion conveying apparatus according to claim 1, wherein the feed rate of said extruder is such that an output pressure of said extruder is at least 10%, in particular more than 20 to 30%, greater than a pressure (P_{ges, min}) that corresponds to a minimum pressure required for complete filling of said volumetrically operating conveyor.

7. An extrusion conveying apparatus according to claim 1, wherein said extruder is adapted to supply the mixture to said volumetrically operating conveyor with an output pressure that is a multiple, in particular 2 to 6 times, of a rated input pressure of said volumetrically operating conveyor.

8. An extrusion conveying apparatus according to claim 1, wherein an output pressure of said extruder is increased to more than 100 bar, in particular to 150-250 bar, and is significantly greater than a rated input pressure of said volumetrically operating conveyor.

9. An extrusion conveying apparatus according to claim 1, wherein said volumetrically operating conveyor has a rated input pressure of 20 to 60 bar, and in particular 40 bar.

10. An extrusion conveying apparatus according to claim 1, wherein said volumetrically operating conveyor is embodied as a planetary pump and has a rated input pressure of between 60 and 100 bar, in particular approximately 80 bar.

11. An extrusion conveying apparatus according to claim 1, wherein said extruder is a screw extruder.

12. An extrusion conveying apparatus according to claim 1, wherein said extruder is a multi-screw extruder, and wherein a plurality of subsidiary conveyors are distributed, in particular in a uniform manner, across said screws.

13. An extrusion conveying apparatus according to claim 1, wherein said extruder provided with at least one throttle region that forms a flow obstacle, and wherein at least one throttle region is disposed downstream of a feeding or supply position of a last one of said subsidiary conveyors.

14. An extrusion conveying apparatus according to claim 1, wherein said extruder is provided with at least one mixing region that is disposed downstream of a feeding or supply position of a last one of said subsidiary conveyors and is embodied as a transfer mix zone and/or as a pin extruder zone.

15. An extrusion conveying apparatus according to claim 1, wherein said volumetrically operating conveyor is embodied as a gear pump, in particular as a planetary pump.

16. An extrusion conveying apparatus according to claim 1, wherein at least one of said subsidiary conveyors is provided with a gear pump, in particular a planetary pump.

17. An extrusion conveying apparatus according to claim 1, wherein a subsidiary extruder is disposed upstream of at least one of said subsidiary conveyors.

18. An extrusion conveying apparatus according to claim 1, wherein a strainer-filter is disposed downstream of said volumetrically operating conveyor, and wherein said strainer-filter is in particular exchangeable and is disposed in a region of enlarged flow cross-section between said volumetrically operating conveyor and an extrusion nozzle.

19. An extrusion conveying apparatus according to claim 1, wherein the n components are comprised of a base mixture and a prebatch, and wherein the prebatch is adapted to be mixed in advance in a separate mixer, in particular an internal mixer.

20. An extrusion conveying apparatus according to claim 1, wherein the mixture is prepared as a thermoplastic elastomer, the components of which are supplied from at least one subsidiary conveyor, in particular a double-screw extruder.
